(19) United States
(12) Patent Application Publication
(10) Pub. No.: US 2009/0005249 A1
(43) Pub. Date: Jan. 1, 2009

(54) METHOD AND COMPOSITION FOR CONTROLLING WEEDS

(75) Inventors: Donald F. Myers, Wake Forest, NC (US); George J. Raymond, Paso Robles, CA (US); David R. Spak, Cary, NC (US)

Correspondence Address: BAYER CROPSCIENCE LP, Patent Department, 2 T .W. ALEXANDER DRIVE, RESEARCH TRIANGLE PARK, NC, 27709, US

(73) Assignee: BAYER CROPSCIENCE LP, Rsearch Triangle Park, NC (US)

(21) Appl. No.: 11/578,915

(22) PCT Filed: Apr. 15, 2005
(86) PCT No.: PCT/US2005/012992

§ 371 Date: Aug. 14, 2008

Related U.S. Application Data
(60) Provisional application No. 60/564,324, filed on Apr. 22, 2004.

(51) Int. Cl. A01N 43/38

(52) U.S. Cl. 504/138

(57) ABSTRACT

The present invention is directed to a novel composition for controlling grassy weeds which includes the combination of a preemergent grassy weed herbicide with a post emergent grassy weed herbicide and to a method of controlling such weeds with the novel composition. The present invention is also directed to a novel composition for controlling grassy weeds and, optionally broadleaf weeds, which novel composition includes the combination of a preemergent grassy weed herbicide, a post emergent grassy weed herbicide and a three-way phenoxy herbicide, and to a method of controlling such grassy weeds and, optionally such broadleaf weeds, with the novel composition. The present invention has been found to be particularly useful for the control of crabgrass in cool season grasses and mixtures of cool season grasses.

### FIELD OF THE INVENTION

The present invention is directed to a novel composition for controlling grassy weeds which includes the combination of a preemergent grassy weed herbicide with a post emergent grassy weed herbicide and to a method of controlling such weeds with the novel composition. The present invention is also directed to a novel composition for controlling grassy weeds and, optionally broadleaf weeds, which novel composition includes the combination of a preemergent grassy weed herbicide, a post emergent grassy weed herbicide and a three-way phenoxy herbicide, and to a method of controlling such grassy weeds and, optionally such broadleaf weeds, with the novel composition. The present invention has been found to be particularly useful for the control of crabgrass in cool season grasses and mixtures of cool season grasses.

### BACKGROUND OF THE INVENTION

Lawn care, golf courses, sod farms, athletic fields and the like all require herbicide treatments to control weeds. It is an important aspect of the herbicidal treatment that it is able to control such weeds without harming the lawn or other turf in which the weeds are found.

In order to control grassy weeds in lawn or turf it is known to treat such grassy weeds with preemergent herbicides. For example, with regard to grassy weeds such as crabgrass, goosegrass or other grassy weeds, it is known to treat a lawn, golf course, sod farm, athletic field or other lawn or turf setting infested with the grassy weeds early in a growing season before the grassy weed has germinated with a preemergent herbicide such as prodiamine.

It is also known to treat grassy weeds such as crabgrass, goosegrass or other grassy weeds after the weed has emerged in the lawn, golf course, sod farm athletic field or other lawn or turf setting, with a post emergent herbicide such as fenoxaprop.

An important limitation is that for stubborn infestations of grassy weeds, this means that at least two different herbicidal compositions must be applied at least twice at different times in the growing season (preemergent and post-emergent), resulting in significant cost and inconvenience.

There are known and commonly used, three-way weed control compositions, sometimes also referred to as phenoxy herbicides, that are used to control a broad spectrum of broadleaf weeds. Such broadleaf weeds, include but are not limited to common dandelion, clover, chickweed, plantain, spurge, hendit, ground ivy, wild garlic, wild onion, wild violet and black medic.

Such three-way weed control herbicidal compositions may include 2,4-Dichlorophenoxyacetic acid (hereinafter referred to as 2,4-D), 2-(2-methyl-4-Chlorophenoxy) proprionic acid also know as mecoprop hereinafter referred to as MCPP), and 3,6-Dichloro-o-anisic Acid (hereinafter referred to as dicamba). These three-way compositions have grown in popularity because while each component alone is insufficient to control a broad spectrum of broadleaf weeds, the combination of the three does often provide effective control of a broad spectrum of broadleaf weeds.

An important limitation of such three-way weed control herbicidal compositions is that they do not control grassy weeds.

It might be suspected that combining a post emergent herbicide for grassy weeds such as fenoxaprop with a three-way broadleaf herbicidal composition might give the best solution for simultaneously controlling both grassy weeds and broadleaf weeds. However, it has been found that combining a post emergent herbicide such as fenoxaprop with a three-way broadleaf herbicide actually results in a net loss of effective weed control, as there is an antagonistic action between such a combination which renders fenoxaprop far less effective for control of grassy weeds when the two are applied in the presence of each other. Therefore, it has heretofore long been generally understood in the art that it was undesirable to combine the post-emergent grassy weed herbicidal composition fenoxaprop with a three-way broadleaf herbicidal composition, and that the two should be applied at different times from one another.

This results in the undesirable and unfortunate need to treat a turf, lawn or other similar locus three different times in order to obtain effective control of grassy and broadleaf weeds. This included a first treatment with a pre-emergent herbicide for control of grassy weeds prior to their germination, followed by a second later treatment with a three-way broadleaf herbicide to control broadleaf weeds, followed after a period of time by a third treatment with a post emergent grassy weed herbicide. This resulted in even greater cost and even greater inconvenience to control grasses that have emerged late in the growing season after the effect of the preemergent application has dissipated. This often occurs in wet growing seasons.

Thus there remains in the art a need for a composition and a method for effectively controlling grassy weeds that is more effective, economical and efficient than is otherwise currently known in the art. There also remains a need in the art for a composition and a method for controlling grassy weeds, and optionally broadleaf weeds, that is more effective, economical and efficient than is otherwise currently known in the art.

### SUMMARY OF THE INVENTION

In one embodiment, the present invention is directed to a novel composition for controlling grassy weeds which includes the combination of a preemergent grassy weed herbicide with a post emergent grassy weed herbicide and to a method of controlling such weeds with the novel composition.

More particularly, the present invention is directed to a novel composition for controlling grassy weeds such as but not limited to crabgrass and/or goosegrass, which composition includes the combination of prodiamine and fenoxaprop.

The present invention is also directed to a method of controlling grassy weeds by applying an effective amount of a composition which includes a combination of a preemergent grassy weed herbicide with a post emergent grassy weed herbicide on or about said weeds and/or their environment.

More particularly the present invention is directed to a method of controlling grassy weeds such as but not limited to crabgrass and/or goosegrass by applying an effective amount of a novel composition which includes a combination of prodiamine and fenoxaprop on or about said weeds and/or their environment.

In a particularly preferred embodiment, the method includes controlling such grassy weeds by applying the novel composition in a single application step.

In another embodiment, the present invention is directed to a novel composition for controlling both grassy weeds and broadleaf weeds which includes the combination of a preemergent grassy weed herbicide, a post emergent grassy weed herbicide and a three-way broadleaf herbicide and to a method of controlling both grassy weeds and broadleaf weeds with said novel composition.

In a preferred embodiment, the present invention is directed to a novel composition for controlling both grassy weeds such as but not limited to crabgrass and/or goosegrass and broadleaf weeds such as but not limited to common dandelion, clover, chickweed, plantain, spurge, hendit, ground ivy, wild garlic, wild onion, wild violet and black medic, which includes the combination of prodiamine, fenoxaprop and a three-way broadleaf herbicidal composition. In a preferred embodiment, the three-way broadleaf herbicidal composition includes 2,4-D, MCPP and dicamba.

The present invention is also directed to a method of controlling grassy weeds and optionally broadleaf weeds by applying an effective amount of a novel composition on or about said weeds and/or their environment, wherein the novel composition includes a preemergent grassy weed herbicide, a post emergent grassy weed herbicide and a three-way broadleaf herbicidal composition.

In a preferred embodiment, the grassy weeds controlled include crabgrass and/or goosegrass, and the novel composition employed in the method includes the combination of prodiamine, fenoxaprop and a three-way broadleaf herbicidal composition. In a still more preferred embodiment, the three-way broadleaf herbicidal composition includes 2,4-D, MCPP and dicamba.

In a preferred embodiment, the method includes controlling such grassy weeds and broadleaf weeds by applying the novel composition in a single application step.

The inventors have found that the novel composition which includes fenoxaprop and prodiamine for the control of grassy weeds exhibits unexpected synergy in the control of such weeds, particularly crabgrass, and permits the crabgrass to be controlled with a single application of the novel composition at the early post emergent phase of the crabgrass growth.

The inventors have found that the novel composition which includes fenoxaprop, prodiamine and a three-way broadleaf herbicidal composition for the control of both grassy weeds and broadleaf weeds exhibits unexpected synergy in the control of such weeds, and, further still, results in an unexpected reduction in the antagonism between the fenoxaprop and the three-way broadleaf herbicide.

Without being bound to any particular theory of operation, the inventors postulate that a possible unexpected residual post emergent control exhibited by prodiamine operates to offset the majority of the antagonism of that exists between phenoxy herbicides and the fenoxaprop.

### DETAILED DESCRIPTION OF THE INVENTION

The term “grassy weeds” as used herein refers to any variety of grassy weeds commonly found in lawn or turf, including but not limited to crabgrass and/or goosegrass. For simplification, in the discussion hereinafter the term crabgrass will be used, and unless otherwise clear from the context, it is used to refer to all grassy weeds commonly found in lawn or turf.

The term “broadleaf weeds” as used herein refers to any variety of broadleaf weeds commonly found in lawn or turf, including but not limited to common dandelion, clover, chickweed, plantain, spurge, hendit, ground ivy, wild garlic, wild onion, wild violet and black medic.

Other than in the operating examples, or where otherwise indicated, all numbers or expressions referring to quantities of ingredients, reaction conditions, etc. used in the specification and claims are to be understood as modified in all instances by the term “about.”

The present invention is directed to a novel composition for controlling grassy weeds which includes the combination of a preemergent grassy weed herbicide with a post emergent grassy weed herbicide and to a method of controlling such weeds with the novel composition. In an alternative embodiment, the present invention is also directed to a novel composition for controlling grassy weeds and, optionally, broadleaf weeds, which novel composition includes the combination of a preemergent grassy weed herbicide, a post emergent grassy weed herbicide and a three-way phenoxy herbicide, and to a method of controlling such grassy and, optionally broadleaf weeds with the novel composition.

It will aid in an understanding of the present invention for those not skilled in the art, to know that the life cycle of grassy weeds occurs in stages which are very well known to those skilled in the art. There is of course the pregermination stage. After germination has begun there is a post germination stage. When the plant rises from the ground it first appears as a shoot and develops leaves. The leaf stage may be characterized by the number of leaves, e.g. 1 leaf stage, 2 leaf stage etc., and is generally characterized as leaves extending from a single shoot or stalk. As the plant matures, tillers develop which are branching, sprouts or stalks that will generally eventually develop leaves of their own. This stage of the weed growth may be characterized by the number of tillers present, such as the 1 tiller stage, the 2 tiller stage, etc.

Thus, stages may be referred to for example as “the preemergence stage”, the “early post germination 1-2 leaf stage”, the “untillered 3-5 leaf stage” and the “tillered” stage which may further be defined as for example, as the “1 tiller stage”, the “2 tiller stage”, the “3+ tiller stage” and the like.

In the discussion that follows, reference may be made to these various stages in the life cycle of the grassy weed, for example, to define generally that period in the life cycle of the weed when a herbicidal composition or compositions have been applied to the weed.

I. Grassy Weeds—The Combination of Fenoxaprop and Prodiamine for Crabgrass Control.

The inventors have found that a combination of a preemergent grassy weed herbicide and a post emergent grassy weed herbicide provides a synergistic ability to control grassy weeds. The present inventors have also found that there are optimum periods during the stage of development of the grassy weeds when the application of this combination of a preemergent grassy herbicide and a post emergent grassy herbicide may have the most beneficial effect in the control of grassy weeds. In particular, the inventors have found that the combination of fenoxaprop and prodiamine provides a synergistic effect in the control of crabgrass when applied at the about the untillered 2 leaf stage to the 3 tillered stage, preferably at about the 5 leaf stage to the 3 tiller stage, and more preferably still to about the 1 to 3 tiller stage of the crabgrass life cycle. Such synergy, for example, meets the Colby formula for calculating synergistic responses, which formula is well known to those skilled in the art.

Any preemergent grassy herbicide may be used in the present invention which provides the synergistic effect herein described. A preferred preemergent herbicide is prodiamine. Particulars of prodiamine include:
5-dipropylamino-α,α,α-trifluoro-4,6-dinitro-o-toluidine or

IUPAC: 2,6-dinitro-N¹,N¹-dipropyl-4-trifluoromethyl-m-phenylenediamine
2,4-dinitro-N³,N³-dipropyl-6-(trifluoromethyl)-1,3-benzenediamine

CAS:

REG. NO.: 29091-21-2

FORMULA: C₁₃H₁₇F₃N₄O₄
herbicides (dinitroaniline herbicides; phenylenediamine herbicides)

ACTIVITY:

NOTES:

STRUCTURE:

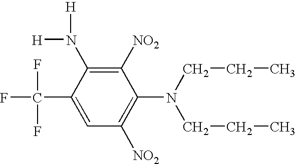

It is available for example, under the trademark “BARRICADE” from Syngenta Professional Products of Greensboro, N.C.

It may be present in the form of liquid formulations, powders, granules or the like, but is preferably in a liquid solution, and more preferably as an aqueous solution.

Any post emergent grassy herbicide may be used in the present invention which provides the synergistic effect herein described. A preferred post emergent herbicide is fenoxaprop. Particulars of fenoxaprop include:
(RS)-2-[4-(6-chloro-1,3-benzoxazol-2-yloxy)phenoxy]propionic acid
or

UPAC: (RS)-2-[4-(6-chlorobenzoxazol-2-yloxy)phenoxy]propionic acid

CAS: 2-[4-[(6-chloro-2-benzoxazolyl)oxy]phenoxy]propanoic acid

REG. NO.: 73519-55-8

FORMULA: C₁₆H₁₂ClNO₅

ACTIVITY: herbicides (aryloxyphenoxypropionic herbicides)
When this substance is used as an ester or a salt, its identity should be stated, for example fenoxaprop-ethyl [66441-23-4]. The (R)-isomer of this substance has the ISO common name fenoxaprop-P.

NOTES:

STRUCTURE:

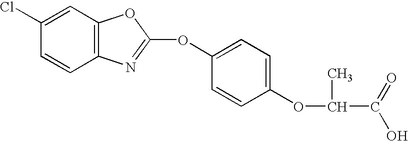

It is available for example, under the trademark “ACCLAIM EXTRA” from Bayer CropScience, LP of Research Triangle Park, North Carolina.

It may be present in the form of liquid formulations, powders, granules or the like, but is preferably in a liquid solution, and more preferably as an aqueous solution.

The fenoxaprop and the prodiamine may be mixed by admixing liquid solutions of the two, by admixing separate granules of the two and/or by providing granules which include both prodiamine and fenoxaprop on or impregnated within the granule.

The combined fenoxaprop/prodiamine composition is applied to the soil generally at a rate high enough to obtain the desired result without damaging the lawn or turf. When fenoxaprop when formulated as Acclaim Extra, (which is 6.59 percent fenoxaprop) is preferably provided at a concentration in the range of about 3.5 fluid ounces per acre to about 39 fluid ounces per acre. Alternatively, in terms of active ingredient per acre, the fenoxaprop is preferably present in a concentration of about 0.045 to 0.09 pounds active ingredient per acre. When formulated as Barricade 4FL, (which is 40.7 percent prodiamine) the prodiamine is preferably provided at a concentration in the range of about 10 fluid ounces per acre to 48 fluid ounces per acre. Alternatively, in terms of active ingredient per acre, the prodiamine is preferably provided in the range of 0.25 to 0.5 pounds active ingredient per acre. Either component, the prodiamine or the fenoxaprop can be varied depending for example, upon the grass or mixture of grasses being treated and upon the level of severity of weed infestation and/or stage of the weed life cycle.

The combination can be applied to the soil by spraying, broadcasting or as is otherwise known in the art.

It may be applied anytime post germination, but has been found to be most effective when applied between the untillered 2 leaf stage to the 3 tillered stage, preferably at about the 5 leaf stage to the 3 tiller stage, and more preferably still to about the 1 to 3 tiller stage of the crabgrass life cycle.

In comparison with the prior art method, the present invention represents a significant advantage over the known methods of controlling grassy weeds, as the combination needs only to be applied once to obtain post emergent control of emerged weeds and preemergent control of grassy weeds not yet emerged.

In one embodiment of the present invention, it is also possible to apply a lower overall amount of herbicidal active ingredient than might otherwise have been necessary if the preemergent herbicidal composition and the post emergent herbicidal composition had been applied separately.

II. Grassy Weeds and Broadleaf Weeds—The Combination of Fenoxaprop, Prodiamine and a Three-Way Herbicide for Grassy Weed Control (e.g. crabgrass) and optionally Broadleaf Weed Control.

The inventors have found that a combination of a preemergent grassy weed herbicide, a post emergent grassy weed herbicide and a three-way broadleaf herbicidal composition provides a synergistic ability to control grassy weeds and, optionally broadleaf weeds, and a very unexpected reduction in the antagonism that is normally present between the post emergent grassy herbicide and the three-way herbicidal composition, which antagonism has been described above. The present inventors have also found that there are optimum periods during the stage of development of the grassy weeds when the application of this combination of a preemergent grassy herbicide, a post emergent grassy herbicide and a three-way broadleaf herbicide may have the most beneficial effect in the control of grassy weeds. In particular, the inventors have found that the combination of fenoxaprop, prodiamine and a three-way broadleaf herbicidal composition provides a synergistic effect in the control of crabgrass when applied at the untillered 2 leaf stage to the 3 tillered stage, preferably at about the 5 leaf stage to the 3 tiller stage, and more preferably still to about the 1 to 3 tiller stage of the crabgrass life cycle. Such synergy, for example, meets the Colby formula for calculating synergistic responses, which formula is well known to those skilled in the art.

Any preemergent grassy herbicide may be used in the present invention which provides the reduction in antagonism herein described. A preferred preemergent herbicide is prodiamine. Particulars of prodiamine have been given above.

Again, it is available for example, under the trademark “BARRICADE” from Syngenta Professional Products of Greensboro, N.C.

Again, in this embodiment of the invention, it may be present in the form of liquid formulations, powders, granules or the like, but is preferably in a liquid solution, and more preferably as an aqueous solution.

Any post emergent grassy herbicide may be used in the present invention which provides the reduction in antagonism herein described. A preferred post emergent herbicide is fenoxaprop. Particulars of fenoxaprop have been given above.

Again, it is available for example, under the trademark “ACCLAIM EXTRA” from Bayer CropScience, LP of Research Triangle Park, North Carolina.

Again, in this embodiment of the present invention, it may be present in the form of liquid formulations, powders, granules or the like, but is preferably in a liquid solution, and more preferably as an aqueous solution.

Any three-way broadleaf herbicidal composition may be used in the present invention which provides the reduction in antagonism herein described. A preferred three-way broadleaf herbicide is LESCO Three-Way Selective Herbicide composition available from LESCO Inc., of Strongsville, Ohio, which is comprised of 2,4-D, MCPP and dicamba.

In this embodiment of the present invention, the three-way herbicidal composition may be present in the form of liquid formulations, powders, granules or the like, but is preferably in a liquid solution, and more preferably as an aqueous solution.

The fenoxaprop, the prodiamine and the three-way herbicidal may be mixed by admixing liquid solutions of the three, by admixing separate granules of the three and/or by providing granules which include all three of prodiamine, fenoxaprop and the three-way herbicidal composition on or impregnated within the granule.

The combined fenoxaprop, prodiamine, three-way herbicidal composition is applied to the soil generally at a rate high enough to obtain the desired result, without damaging the lawn or turf wherein the weeds are found. Concentrations the fenoxaprop to prodiamine to be applied to the soil are the same as those described above. The additional component of this embodiment of the invention, namely the three-way broadleaf herbicidal composition may be present in the range of about 2 to 4 pints per acre based upon a 30.56 percent 2,4-D, 16.34% MCPP and 2.77% dicamba three-way herbicidal composition. Again, any one or all of the three components, the prodiamine, the fenoxaprop and/or the three-way herbicidal composition can be varied depending for example, upon the grass or mixture of grasses being treated and upon the level of severity of weed infestation and/or stage of the weed life cycle.

The combination of fenoxaprop, prodiamine and three-way herbicidal composition can be applied to the soil by spraying, broadcasting or the like.

It may be applied anytime post germination, but has been found to be most effective when applied at the about the untillered 2 leaf stage to the 3 tillered stage, preferably at about the 5 leaf stage to the 3 tiller stage, and more preferably still to about the 1 to 3 tiller stage of the crabgrass life cycle.

In comparison with the prior art method, the present invention represents a significant advantage over the known methods of controlling grassy weeds, as the combination needs only to be applied once to obtain post emergent control of emerged weeds and preemergent control of grassy weeds not yet emerged and can be applied with the three-way herbicide without the antagonism that has presented such a problem in the past.

In one embodiment of the present invention, it is also possible to apply a lower overall amount of herbicidally active ingredients than might otherwise have been necessary if the preemergent herbicidal composition, the post emergent herbicidal composition and the three-way herbicidal composition had been applied separately.

III. Advantages

There are several advantages of the present invention. This include decreased usage of herbicidally active ingredients to obtain results that are the same as or superior to known methods of controlling grassy weeds which results in decreasing consumer concerns over pesticide use. The present invention provides a broader window of application timing for the applicator or others wishing to control such grassy and optionally, broadleaf weeds. Efficiencies and economies are improved where a single application provides a season long control program. It fits integrated pest management programs (“IPM”) programs, by waiting until an infestation is present before chemical solutions are used rather than treating preventatively. This approach is much desired by consumers and government officials. The present invention provides improved post-emergent control of grassy weeds, particularly crabgrass. In general, the present invention provides an excellent herbicide resistance management tool.

The following examples explain the invention in more detail, but without limiting it.

### EXAMPLE 1

Crop & Pest: Mixed cool season grasses/Crabgrass—Digitaria sp.

Objective: Evaluate combinations of Acclaim Extra (fenoxaprop) and Barricade (prodiamine) for control of crabgrass in mixtures of cool season grasses that might be found in a lawn care situation.

Summary: A single application of Acclaim Extra (3.5 oz/A) applied at the 1-3 leaf stage resulted in poor control of smooth crabgrass. The addition of Barricade (21.0 oz/A) to Acclaim Extra (3.5) improved control when compared to Acclaim Extra alone. The tank mix combination of Acclaim and Barricade was similar in control as Barricade, when applied alone at the 1-3 leaf stage. Both of these two treatments were not significantly different than Barricade (21.0) applied as a preemergent.

Barricade applied alone at the 3-5 leaf stage, indicated adequate control on the initial rating date. Although, Barricade (3-5 leaf) failed to show adequate control by the later rating date. A single application of Acclaim Extra (9.0 oz/A) applied at the 3-5 leaf stage resulted in poor control of smooth crabgrass. Acclaim Extra (9.0)+Barricade (21.0) had excellent control of crabgrass at the 3-5 leaf stage. Acclaim Extra (28.0) applied alone and in combination with Barricade (21.0) showed excellent control of crabgrass at the tiller stage. Pendulum (0.5 gal/A) had moderate to poor control of crabgrass when applied as a preemergent.

### EXAMPLE 2

Crop & Pest: Cool season grasses/Crabgrass

Objective: Evaluate combinations of Acclaim Extra (fenoxaprop) and Barricade (prodiamine) for control of crabgrass in mixtures of cool season grasses that might be found in a lawn care situation.

Summary: Treatments were applied at four different crabgrass timings to a Kentucky bluegrass turf to evaluated crabgrass control and turf safety.

Timings included: preemergence (April 29), 1 to 2 leaf (May 19), 1 to 3 tiller (July 10), and 3+ tiller crabgrass (August 5). Application timing and treatment had a significant impact on final crabgrass control evaluated in on September 9.

Preemergence applications of Barricade and Pendulum were unacceptable, providing less than 85% control, although Barricade was more effective.

At the 1 to 2 leaf timing, Acclaim was ineffective, presumably due to continued germination. Acclaim+Barricade at 1 to 2 leaf provided good control, but Barricade by itself was also very effective indicating that the Acclaim was really not adding anything at this timing. The fact that Barricade provided good control at this timing was also unexpected. Also, Acclaim+Pendulum (formerly Preclaim) failed to provide good control, which has historically performed well.

At the 1 to 3 tiller timings, the combinations of Acclaim+Barricade were very effective and more effective than Acclaim alone. Only the 13 oz of Acclaim was required in the mix for acceptable control, since the 20 oz rate did not improve control. Barricade was not applied alone at this timing, since it would not be expected to provide any control.

At 3+ tiller, Acclaim alone provided excellent control, but the Acclaim+Barricade slightly increased control. It appears that Barricade provided some levels of post emergence crabgrass activity not previously expected.

In summary, Acclaim+Barricade is an excellent combination with the benefits most evident at the 1 to 3 tiller timing in July, and it appears that Acclaim rates may be reduced when used in combination with Barricade, which will reduce cost, something very important in this market. With earlier applications, Barricade alone is effective, with later applications, Acclaim alone is effective. However, a combination product is indicated with a wider window than either applied alone, but probably not later than the month of July, with mid-May through mid-July as the preferred window of application.

### EXAMPLE 3

Crop & Pest: Cool season grasses/Crabgrass

Objective: Evaluate combinations of Acclaim Extra (fenoxaprop) and Barricade (prodiamine) and a three-way broadleaf herbicide for control of crabgrass in mixtures of cool season grasses that might be found in a lawn care situation.

Summary:

Crabgrass pressure was very high in this study, and on the final rating date on August 25, the untreated check plots had nearly 100% cover. A rating of 85% or higher would be considered commercially acceptable. Acclaim+Barricade provided excellent control at all application rates and timings, and was better than Acclaim alone or Barricade alone.

At the early timing, Barricade alone provided about 80% control, displaying good post emergence activity, this was unexpected.

At the late application timing, Acclaim+Pendimethalin (formerly Preclaim) also gave excellent control and was not significantly different than Acclaim+Barricade. Three-way herbicide significantly antagonized Acclaim Extra. However, the addition of Barricade to Acclaim+Three Way seemed to reduce the antagonism, and provided acceptable control of crabgrass and broadleaf weeds at the 1-2 tiller timing. This combination was unacceptable at early and later timings even with increasing Acclaim rates, but was still better than Acclaim+Three Way.

In summary, Acclaim+Barricade provided excellent control at the rates and timings evaluated, suggesting a wide window of application for this combination. Also, Barricade does provide some post emergence activity, and seems to add to the activity of Acclaim. This activity also seems to offset the majority of antagonism that exists with Acclaim+phenoxy herbicides. A three-way combination of Acclaim+Barricade+broadleaf herbicide provides a complete, one-pass material/one application for total weed control in home lawns.

### EXAMPLE 4

Crop & Pest: Cool season grasses/Crabgrass

Objective: Evaluate combinations of Acclaim Extra (fenoxaprop), Barricade (prodiamine), three-way broadleaf herbicides, and other adjuvants for control of crabgrass in mixtures of cool season grasses that might be found in a lawn care situation.

Summary: Treatments were applied to multitillered crabgrass (5+ tiller), prior to flowering, a timing that would be considered a “rescue” treatment in a lawn care or golf course situation. Crabgrass cover was nearly 100% at the time of application. The herbicidal effects were significant at 8 days after treatment (“DAT”), but were greatest at 18 DAT and crabgrass control ratings peaked at this time.

By 6 weeks after treatment (“WAT”), crabgrass that was not completely controlled began to recover and some treatments were not providing acceptable control (85% or greater).

At 8 DAT, all treatments were causing injury to the crabgrass, but Drive was causing the greatest injury at nearly 95%. The addition of Barricade, Macrosorb, or Kinetic silicone surfactant were not improving crabgrass injury at this time. Both Momentum and Three Way were reducing the effects of Acclaim.

At 18 DAT, Acclaim alone was providing acceptable control at 20 and 28 oz/A, but was unacceptable at 10 oz as would be expected. The addition of Barricade to Acclaim tended to increase control. Momentum and 3-Way both significantly decreased Acclaim activity, but the addition of Barricade to these mixes increased crabgrass control, but were still not commercially acceptable. Interestingly, Stomp (pendimethalin) added to this mix was unable to offset the antagonism like Barricade. Macrosorb applied at 2 oz or the addition of a non-ionic surfactant did not improve crabgrass control.

Final control, evaluated at 6 WAT, declined with most treatments due to crabgrass regrowth and no treatment including Drive provided complete control. Only the following treatments provided acceptable control, Acclaim 28 oz+Barricade, Acclaim 28 oz+Stomp, Drive+Hasten. This test was applied late, and typically a preemergence herbicide would not be applied at this timing. However, it served to separate the effects of products that may enhance or antagonize Acclaim. The antagonism of three-way herbicides was clearly shown. Barricade, but not pendimethalin served to substantially offset the antagonism. Macrosorb did not improve the activity of Acclaim at any time, and a non-ionic surfactant generally had no effect.

### EXAMPLE 5

Crop & Pest: Cool season grasses/Crabgrass

Objective: Evaluate combinations of Acclaim Extra (fenoxaprop) and Barricade (prodiamine) for control of crabgrass in mixtures of cool season grasses that might be found in a lawn care situation.

Summary: This trial was conducted on the University of Nebraska Turf Research facility at Mead, Neb. Applications of Acclaim Extra, Barricade 4FL and/or various combinations thereof were made to Kentucky Bluegrass prior to crabgrass emergence (May 23, 2003), 1-2 leaf stage (June 27), >2 leaf stage but untillered (July 15) and after tillering (August 13). Evaluations of crabgrass control were made July 15, Aug. 7, Aug. 14, Aug. 20, Aug 26 and Sept. 2. No phytotoxicity of the turfgrass was observed.

The best treatments were combinations of Acclaim+Barricade at the pre-tiller stage, 20+21 and 13 and 21 oz/acre and application at 1-2 leaf at 9+21 oz, respectively, consistently exceeding 90% control. However, Barricade alone pre-emergence provided over 80% control throughout the season. Acclaim Extra, alone at 13 and 20 oz/acre applied to pre-tillered crabgrass, was not significantly different from the aforementioned treatments (>=70%).

The best treatment prior to tillering, Acclaim Extra+Barricade at 20+21 oz/acre was less than satisfactory applied post tillering. The addition of Barricade to Acclaim improved the control of crabgrass, at all three post-emergent stages by ca. 15-20% compared to the same rate of Acclaim alone.

### EXAMPLE 6

Crop & Pest: Cool season grasses/Crabgrass

Objective: Evaluate combinations of Acclaim Extra (fenoxaprop) and Barricade (prodiamine) for control of crabgrass in mixtures of cool season grasses that might be found in a lawn care situation.

Summary: This trial was conducted based on Revision 2 of the protocol.

Both Barricade and Pendulum applied pre-emergence to the crabgrass provided over 96% control but control dropped off dramatically with later timings. The addition of Acclaim Extra allowed control to stay at or above 96% control at 3.5 fl oz/A at 1-2 leaf and at 9 fl oz at 1 tiller. Once the crabgrass was tillered even 28 fl oz added to Barricade did not provide adequate levels of control. Based on this trial the addition of Acclaim Extra extends the window of timing for a one-application residual crabgrass control into the 1 tiller crabgrass timing.

### EXAMPLE 7

Crop & Pest: Cool season grasses/Crabgrass

Objective: Evaluate combinations of Acclaim Extra (fenoxaprop) and Barricade (prodiamine) for control of crabgrass in mixtures of cool season grasses that might be found in a lawn care situation.

Summary: 21 fl oz/A Barricade applied pre-emerge in early May or early post-emerge (May 22) for control of crabgrass performed poorly. 9 fl oz/A Acclaim Extra applied early post emerge provided excellent control up to July 24 when control dropped from 99% to 89%. By Aug 18 crabgrass control dropped further to 79% probably due to later spring germinating crabgrass.

The tank-mix of the two above treatments showed excellent control from June 1 right through to Aug 18.

13 fl oz/A Acclaim Extra applied at the 3-4 leaf stage untillered stage of crabgrass (July 8) exhibited excellent control of crabgrass as did the tank-mix of 13 fl oz/A Acclaim Extra plus 21 fl oz/A of Barricade.

20 fl oz/A Acclaim Extra applied at the tillered stage of crabgrass (Aug 5) showed poor control of crabgrass as did the tank-mix of 20 fl oz/A Acclaim Extra plus 21 fl oz/A of Barricade.

Pendulum 0.5 gal/A applied Pre-emerge (early May) provided excellent control of crabgrass and was equal to the tank-mix of 9 fl oz/A Acclaim Extra plus 21 fl oz/A of Barricade applied early post-emerge on May 12.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition for controlling grassy weeds comprising a combination of a preemergent grassy weed herbicide with a post emergent grassy weed herbicide.

2. The composition of claim 1 wherein the preemergent grassy weed herbicide is prodiamine and the post emergent grassy weed herbicide is fenoxaprop.

3. The composition of claims 1 or 2 wherein the grassy weeds are selected from the group consisting of crabgrass, goosegrass and combinations thereof.

4. A method of controlling grassy weeds comprising applying an effective amount of a composition which includes a combination of a preemergent grassy weed herbicide with a post emergent grassy weed herbicide on or about said weeds and/or their environment.

5. The method of claim 5 wherein the preemergent grassy weed herbicide is prodiamine and the post emergent grassy weed herbicide is fenoxaprop.

6. The method of claims 4 or 5 wherein the grassy weeds are selected from the group consisting of crabgrass, goosegrass and combinations thereof.

7. The method of claims 4, 5, or 6 further comprising the step of controlling said grassy weeds by applying the composition in a single application step.

8. The method of claim 7 wherein the application step is performed post germination of said grassy weeds.

9. The method of claim 8 wherein said application step is performed during a period between post germination of said grassy weeds and before a 3 tiller stage of development of said grassy weeds.

10. The method of claim 9 wherein said application step is performed during a period between an untillered 2 leaf stage and a 3 tillered stage of development of said grassy weeds.

11. The method of claim 10 wherein said application step is performed during a period between an untillered 5 leaf stage and a 3 tillered stage of development of said grassy weeds.

12. The method of claim 11 wherein said application step is performed during a period between a 1 to 3 tillered stage of development of said grassy weeds.

13. A composition for controlling grassy weeds and, optionally broadleaf weeds, comprising a combination of a preemergent grassy weed herbicide, a post emergent grassy weed herbicide and a three-way broadleaf weed herbicide.

14. The composition of claim 13 wherein the preemergent grassy weed herbicide is prodiamine and the post emergent grassy weed herbicide is fenoxaprop.

15. The composition of claims 13 or 14 wherein the three-way broadleaf weed herbicide comprises 2,4-D, MCPP and dicamba.

16. The composition of claims 13, 14 or 15 wherein the grassy weeds are selected from the group consisting of crabgrass, goosegrass and combinations thereof.

17. The composition of claims 13, 14, 15, or 16 wherein the broadleaf weeds are selected from the group consisting of include but are not limited to common dandelion, clover, chickweed, plantain, spurge, hendit, ground ivy, wild garlic, wild onion, wild violet and black medic.

18. A method of controlling grassy weeds and, optionally broadleaf weeds, by applying an effective amount of a composition on or about said weeds and/or their environment, wherein the composition includes a preemergent grassy weed herbicide, a post emergent grassy weed herbicide and a three-way broadleaf herbicidal composition.

19. The method of claim 18 wherein the preemergent grassy weed herbicide is prodiamine, the post emergent grassy weed herbicide is fenoxaprop, and the three-way broadleaf weed herbicidal composition is a phenoxy herbicidal composition.

20. The method of claim 19 wherein the three-way broadleaf weed herbicidal composition comprises 2,4-D, MCPP and dicamba.

21. The method of claims 18, 19 or 20 wherein the grassy weeds are selected from the group consisting of crabgrass, goosegrass and combinations thereof.

22. The method of claims 18, 19, 20 or 21 wherein the broadleaf weeds are selected from the group consisting of include but are not limited to common dandelion, clover, chickweed, plantain, spurge, hendit, ground ivy, wild garlic, wild onion, wild violet and black medic.

23. The method of claims 18, 19, 20, 21 or 22 further comprising the step of controlling said grassy weeds by applying the composition in a single application step.

24. The method of claim 23 wherein the application step is performed post germination of said grassy weeds.

25. The method of claim 24 wherein said application step is performed during a period between post germination of said grassy weeds and before a 3 tiller stage of development of said grassy weeds.

26. The method of claim 25 wherein said application step is performed during a period between an untillered 2 leaf stage and a 3 tillered stage of development of said grassy weeds.

27. The method of claim 26 wherein said application step is performed during a period between an untillered 5 leaf stage and a 3 tillered stage of development of said grassy weeds.

28. The method of claim 27 wherein said application step is performed during a period between a 1 to 3 tillered stage of development of said grassy weeds.

29. The method of claim 18 wherein there is a reduced level of antagonism between said post emergent grassy weed herbicide and said three-way broadleaf herbicidal composition in the presence of said preemergent grassy weed herbicide over a level of an antagonism between said post emergent grassy weed herbicide and said three-way broadleaf herbicidal composition in the absence of said preemergent grassy weed herbicide.

30. The method of claim 29 wherein said preemergent grassy weed herbicide is prodiamine, said post emergent grassy weed herbicide is fenoxaprop and said three-way herbicidal composition is a phenoxy herbicidal composition.

31. The method of claim 30 wherein said phenoxy herbicidal composition comprises 2,4-D, MCPP and dicamba.

32. The composition of claim 1 wherein said grassy weeds are present in a cool season grass or mixture of cool season grasses.

33. The method of claim 4 wherein said grassy weeds are present in a cool season grass or mixture of cool season grasses.

34. The composition of claim 13 wherein said grassy weeds are present in a cool season grass or mixture of cool season grasses.

35. The method of claim 18 wherein said grassy weeds are present in a cool season grass or mixture of cool season grasses.

36. The composition of claim 2 wherein said fenoxaprop and said prodiamine are present in said composition by admixing liquid solutions of the two, by admixing separate granules of the two and/or by providing granules which include both prodiamine and fenoxaprop on or impregnated within the same granule.

37. The method of claim 5 wherein said fenoxaprop and said prodiamine are present in said composition by admixing liquid solutions of the two, by admixing separate granules of the two and/or by providing granules which include both prodiamine and fenoxaprop on or impregnated within the same granule.

38. The method of claim 19 wherein said fenoxaprop and said prodiamine are present in said composition by admixing liquid solutions of the two, by admixing separate granules of the two and/or by providing granules which include both prodiamine and fenoxaprop on or impregnated within the same granule.
